(19) United States
(12) Patent Application Publication
(10) Pub. No.: US 2024/0163791 A1
(43) Pub. Date: May 16, 2024

(54) ALIGNED TARGET WAKE TIME OPERATION IN WIRELESS COMMUNICATION SYSTEMS

(71) Applicant: Samsung Electronics Co., Ltd., Suwon-si (KR)

(72) Inventors: Rubayet Shafin, Allen, TX (US); Vishnu Vardhan Ratnam, Plano, TX (US); Boon Loong Ng, Plano, TX (US)

(21) Appl. No.: 18/458,048

(22) Filed: Aug. 29, 2023

Related U.S. Application Data
(60) Provisional application No. 63/424,365, filed on Nov. 10, 2022.
(60) Provisional application No. 63/431,564, filed on Dec. 9, 2022.
(60) Provisional application No. 63/439,482, filed on Jan. 17, 2023.

(51) Int. Cl. H04W 52/02

(52) U.S. Cl. CPC H04W 52/0216

(57) ABSTRACT

A wireless communication network includes an access point (AP) multi-link device (MLD) and a non-AP MLD. A target wake time (TWT) scheduling AP affiliated with the AP MLD transmits a broadcast frame announcing a broadcast TWT schedule to a TWT scheduled station (STA) affiliated with the non-AP MLD. The broadcast frame indicates whether there is a schedule on other link that is aligned with the TWT schedule. When the TWT scheduled STA is interested in joining the aligned schedule, it transmits a request to join the aligned schedule on the link.

### CROSS-REFERENCE TO RELATED APPLICATIONS

This application claims the benefit of priority from U.S. Provisional Application No. 63/424,365, entitled “METHOD AND APPARATUS FOR ALIGNED TARGET WAKE TIME OPERATION” filed Nov. 10, 2022; U.S. Provisional Application No. 63/431,564, entitled “METHOD AND APPARATUS FOR ALIGNED TARGET WAKE TIME OPERATION,” filed Dec. 9, 2022; and, U.S. Provisional Application No. 63/439,482, entitled “METHOD AND APPARATUS FOR ALIGNED TARGET WAKE TIME OPERATION,” filed Jan. 17, 2023, all of which are incorporated herein by reference in their entirety.

### TECHNICAL FIELD

This disclosure relates generally to a wireless communication system, and more particularly to, for example, but not limited to, target wake time (TWT) operation in the wireless communication system.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One embodiment of the present disclosure may provide an access point (AP) multi-link device (MLD) associated with a non-AP MLD in a wireless network. The AP MLD may comprise at least two APs and a processor coupled to the at least two APs. The processor is configured to transmit, by a first AP affiliated with the AP MLD to a first STA affiliated with the non-AP MLD on a first link between the first AP and a first STA, a first broadcast frame announcing a first TWT schedule, the first broadcast frame indicating whether the first TWT schedule is an aligned schedule. The processor is configured to receive, by the first AP from the first STA on the first link, a first request to join the first TWT schedule. The processor is configured to establish, by the first AP on the first link, the first TWT schedule that is aligned with a second TWT schedule established on a second link between a second AP affiliated with the AP MLD and a second STA affiliated with the non-AP MLD.

In some embodiments, the first broadcast frame comprises a TWT element that includes an aligned subfield indicating whether the aligned schedule is available on more than one of links of the AP MLD.

In some embodiments, when the aligned subfield is set to a first value, the aligned subfield indicates that there is a schedule on other link that is aligned within a predetermined interval with the first TWT schedule on the first link.

In some embodiments, when the aligned subfield is set to a second value, the aligned subfield indicates that there is no schedule on other link that is aligned within a predetermined interval with the first TWT schedule on the first link.

In some embodiments, the aligned subfield is reserved when a negotiation type subfield of a control field of the TWT element indicates that the first AP manages a membership in a TWT schedule by including the TWT element in an individually addressed management frame.

In some embodiments, the aligned schedule is a broadcast TWT schedule that is available across multiple links and target wake times of broadcast TWT schedules on the multiple links are aligned.

In some embodiments, TWT parameters of aligned TWT schedules on the multiple links are same as each other.

In some embodiments, the processor is configured to transmit, by the second AP to the second STA on the second link, a second broadcast frame announcing the second TWT schedule. The processor is configured to receive, by the second AP from the second STA on the second link, a second request to join the second TWT schedule that is aligned with the first TWT schedule established on the first link. The processor is configured to establish, by the second AP on the second link, the second TWT schedule.

In some embodiments, the processor is configured to transmit, by a third AP affiliated with the AP MLD from a third STA affiliated with the non-AP MLD on a third link between the third AP and the third STA, a third broadcast frame announcing a third TWT schedule. The processor is configured to receive, by the third AP from the third STA on the third link, a third request to join the third TWT schedule that is aligned with the first TWT schedule established on the first link. The processor is configured to establish, by the third AP on the third link, the third TWT schedule.

On embodiment of present disclosure may provide a non-access point (AP) multi-link device (MLD) associated with an AP MLD in a wireless network. The non-AP MLD may comprise at least two stations (STAs) and a processor coupled to the at least two STAs. The processor is configured to receive, by a first STA affiliated with the non-AP MLD from a first AP affiliated with the AP MLD on a first link between the first STA and the first AP, a first broadcast frame announcing a first TWT schedule, the first broadcast frame indicating whether the first TWT schedule is an aligned schedule. The processor is configured to transmit, by the first STA to the first AP on the first link, a first request to join the first TWT schedule. The processor is configured to and join the first TWT schedule that is established on the first link, the first TWT schedule being aligned with a second TWT schedule established on a second link between a second STA affiliated with the non-AP MLD and a second AP affiliated with the AP MLD.

In some embodiments, the first broadcast frame comprises a TWT element that includes an aligned subfield indicating whether the aligned schedule is available on more than one of links of the AP MLD.

In some embodiments, when the aligned subfield is set to a first value, the aligned subfield indicates that there is a schedule on other link that is aligned within a predetermined interval with the first TWT schedule on the first link.

In some embodiments, when the aligned subfield is set to a second value, the aligned subfield indicates that there is no schedule on other link that is aligned within a predetermined interval with the first TWT schedule on the first link.

In some embodiments, the aligned subfield is reserved when a negotiation type subfield of a control field of the TWT element indicates that the first AP manages a membership in a TWT schedule by including the TWT element in an individually addressed management frame.

In some embodiments, the aligned schedule is a broadcast TWT schedule that is available across multiple links and target wake times of broadcast TWT schedules on the multiple links are aligned.

In some embodiments, TWT parameters of aligned TWT schedules on the multiple links are same as each other.

In some embodiments, the processor is configured to receive, by the second STA from the second AP on the second link, a second broadcast frame announcing the second TWT schedule. The processor is configured to determine, by the second STA, that the second TWT schedule is the aligned schedule that is aligned with the first TWT schedule based on TWT parameters of the second TWT schedule. The processor is configured to transmit, by the second STA to the second AP on the second link, a second request to join the second TWT schedule. The processor is configured to join the second TWT schedule that is established on the second link, the second TWT schedule being aligned with the first TWT schedule established on the first link.

In some embodiments, the processor is configured to receive, by a third STA affiliated with the non-AP MLD from a third AP affiliated with the AP MLD on a third link between the third STA and the third AP, a third broadcast frame announcing a third TWT schedule. The processor is configured to determine, by the third STA, that the third TWT schedule is the aligned schedule that is aligned with the first TWT schedule based on TWT parameters of the third TWT schedule. The processor is configured to transmit, by the third STA to the third AP on the second link, a third request to join the third TWT schedule. The processor is configured to join the third TWT schedule that is established on the third link, the third TWT schedule being aligned with the first TWT schedule established on the first link.

One embodiment of present disclosure may provide a computer-implemented method for facilitating wireless communication. The method may comprise receiving, by a first station (STA) affiliated with a non-access point (AP) multi-link device (MLD) from a first AP affiliated with an AP MLD associated with the non-AP MLD on a link between the first AP and the first AP, a broadcast frame announcing a broadcast TWT schedule, the broadcast frame indicating whether the broadcast TWT schedule is an aligned schedule. The method may comprise transmitting, by the first STA to the first AP on the link, a request to join the broadcast TWT schedule when the first STA is interested in joining the broadcast TWT schedule. The method may comprise joining the broadcast TWT schedule that is established on the link, the broadcast TWT schedule being aligned with another broadcast TWT schedule established on other link between the non-AP MLD and the AP MLD.

In some embodiments, the broadcast frame comprises a TWT element that includes an aligned subfield indicating whether the aligned schedule is available on more than one of links of the AP MLD.

### BRIEF DESCRIPTION OF THE DRAWINGS

FIG. 1 shows an example of a wireless network in accordance with an embodiment.

FIG. 2A shows an example of an AP in accordance with an embodiment.

FIG. 2B shows an example of a STA in accordance with an embodiment.

FIG. 3 shows an example of multi-link operation in accordance with an embodiment.

FIG. 4 shows an example of an aligned TWT schedule in accordance with an embodiment.

FIG. 5 shows an example of a TWT element in accordance with an embodiment.

FIG. 6A shows an example of an Aligned TWT information element in accordance with an embodiment.

FIG. 6B shows an example of a control field of an Aligned TWT information element in accordance with an embodiment.

FIG. 6C shows another example of a control field of an Aligned TWT information element in accordance with an embodiment.

FIG. 6D shows an example of Aligned TWT Parameter Set field included in the Aligned TWT information element.

FIG. 6E shows another example of Aligned TWT Parameter Set field included in the Aligned TWT information element.

FIG. 6F shows another example of Aligned TWT Parameter Set field included in the Aligned TWT information element.

FIG. 7 shows another example of an Aligned TWT information element in accordance with an embodiment.

FIG. 8 shows another example of an Aligned TWT information element in accordance with an embodiment.

FIG. 9 shows a flow chart illustrating an example process for an AP MLD that supports aligned TWT operation in accordance with an embodiment.

FIG. 10 shows a flow chart illustrating an example process for a non-AP MLD that supports aligned TWT operation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

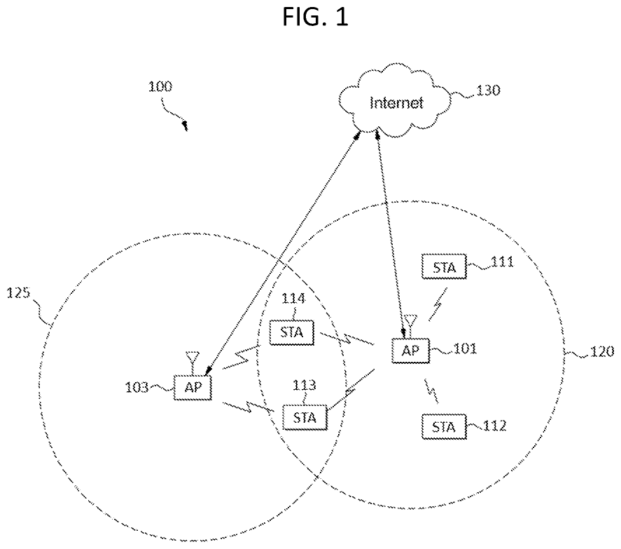

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

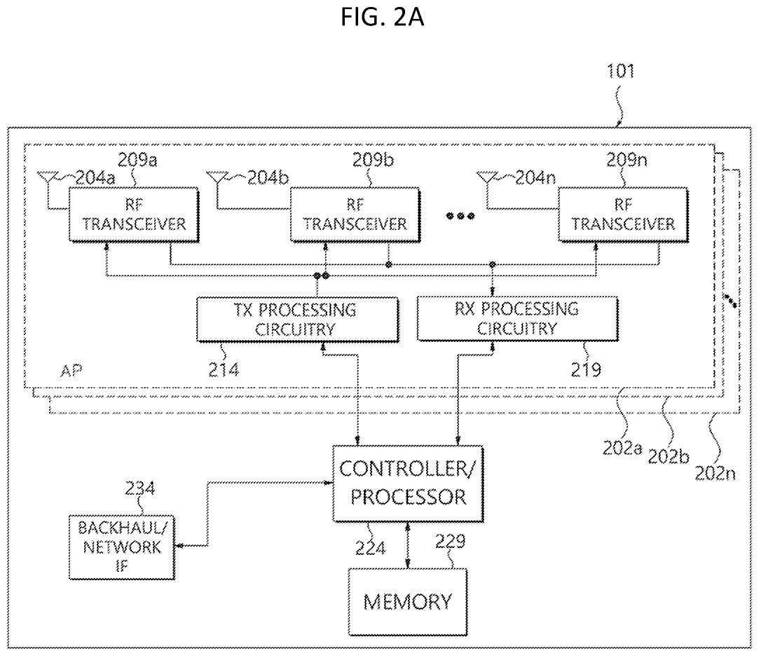

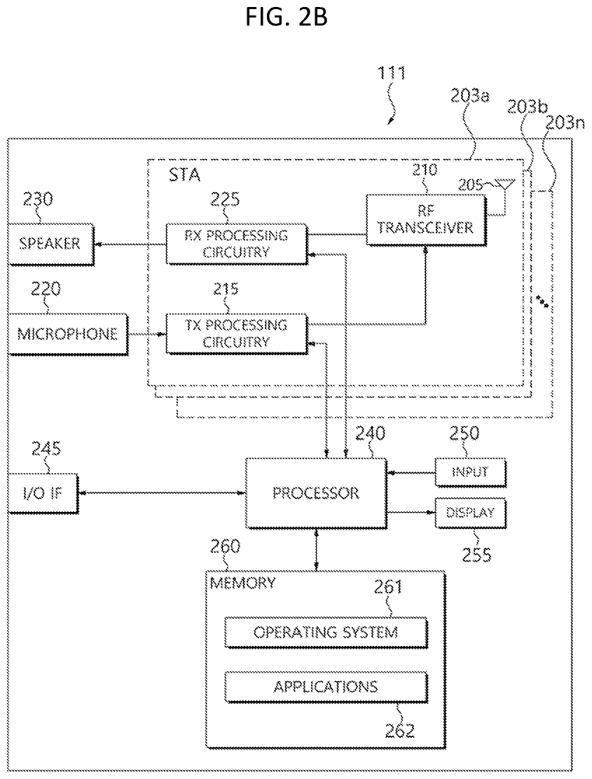

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

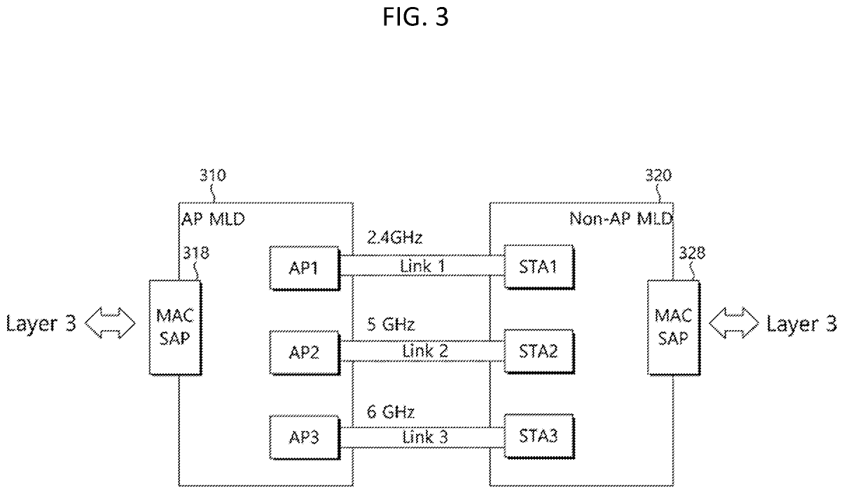

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2 and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency.

Target wake time (TWT) operation is a feature for power management in WLAN networks. The TWT operation has been introduced in IEEE 802.11ah standard and later modified in IEEE 802.11ax standard. In TWT operation, a STA may wake up only at pre-scheduled times that have been negotiated with a AP or another STA in the basic service set (BSS). The IEEE 802.11ax standard describes two types of TWT operations: individual TWT operation and broadcast TWT operation. In the individual TWT operation, an individual TWT agreement can be established between two STAs or between a STA and an AP. On the other hand, in the broadcast TWT operation, an AP can set up a shared TWT session for a group of STAs. IEEE 802.11be standard describes a restricted TWT (R-TWT) operation that can provide more predictable latency with higher reliability for latency-sensitive traffic in a timely manner. The R-TWT operation is based on broadcast TWT operation. The TWT operation is one of the important features to support low-latency application in the next generation of WLAN system.

Latency-sensitive traffic may be bursty and periodic. When there is a traffic identifier (TID) associated with latency-sensitive traffic, a non-AP MLD may prefer to map the TID associated with latency-sensitive traffic to more than one or all setup links. For the TID associated with latency-sensitive traffic, STAs affiliated with the non-AP MLD may wake up at the same time on multiple links so that the latency-sensitive traffic with the TID can flow over the multiple links, thereby increasing the channel access opportunity for the latency-sensitive traffic. In this scenario, the non-AP MLD may benefit from becoming a member of TWT schedules that are aligned across multiple links. However, the broadcast TWT schedules established across the multiple links may not possibly be aligned across multiple links by TWT scheduling APs affiliated with the AP MLD in current WLAN systems. Accordingly, the AP MLD may need to align or synchronize a specific set of TWT schedules across multiple links and indicate which TWT schedules are aligned across multiple links during broadcast TWT announcement phase. However, currently, there is no mechanism in place for aligned TWT schedule or announcing such alignment.

In some embodiments, an aligned schedule is a broadcast TWT schedule that is offered across multiple links by APs affiliated with an AP MLD where the target wake time (TWT) of the schedule on the multiple setup links are aligned and TWT parameters for the aligned schedules on multiple links are the same as each other.

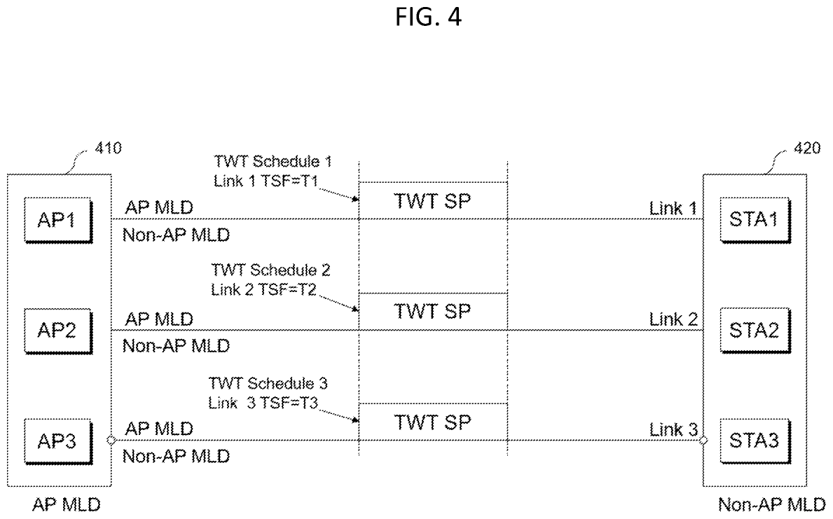

FIG. 4 shows an example of an aligned TWT schedule in accordance with an embodiment. This example may be applicable to IEEE 802.11be standard and any future amendments to IEEE 802.11 standard. The AP MLD 410 and the non-AP MLD 420 may be examples of the AP MLD 310 and the non-AP MLD 320 illustrated in FIG. 3, respectively. The AP MLD 410 may include three affiliated APs (AP 1, AP 2, and AP 3), and the non-AP MLD 420 may include three affiliated STAs (STA 1, STA 2, and STA 3). AP 1 and STA 1 may operate on Link 1, AP 2 and STA 2 may operate on Link 2, and AP 3 and STA 3 may operate on Link 3. For example, Link 1, Link 2, and Link 3 may use the 2.4 GHz frequency band, the 5 GHz frequency band, and the 6 GHz frequency band, respectively.

Referring to FIG. 4, a broadcast TWT schedule 1 is established on Link 1 between AP 1 and STA 1. Similarly, a broadcast TWT schedule 2 is established on Link 2 between AP 2 and STA 2, a broadcast TWT schedule 3 is established on Link 3 between AP 3 and STA 3. In FIG. 4, broadcast TWT schedules 1-3 are aligned with each other on their respective links. In some implementations, the timing synchronization function (TSF) values T1, T2, and T3 on Link 1, Link 2, and Link 3 indicate the start times of TWT service periods (SPs) for broadcast TWT schedules 1-3 on their respective links. These values may be aligned with each other as shown in FIG. 4.

In FIG. 4, the AP MLD 410 may establish three broadcast TWT schedules across multiple links, such as Link 1, Link 2, and Link 3. However, since TWT scheduled STAs affiliated with the non-AP MLD 420 operate independently on their respective links, the TWT scheduled STAs operating on their respective links may be not aware of which TWT schedules are aligned schedule. Accordingly, if a schedule is marked or indicated as “aligned” schedule during the advertisement or announcement phase, the TWT scheduled STAs affiliated with the non-AP MLD may gain advantage by joining the aligned schedule across multiple links, thereby enhancing the performance of their latency-sensitive applications.

In some implementations, APs affiliated with the AP MLD may advertise or announce which the TWT schedule is an aligned schedule. For instance, APs of the AP MLD may transmit a broadcast frame on their respective links, indicating if the corresponding TWT schedule is aligned schedule. More specifically, the indication about the aligned TWT schedule may be included in a broadcast TWT parameter set field of a broadcast TWT element.

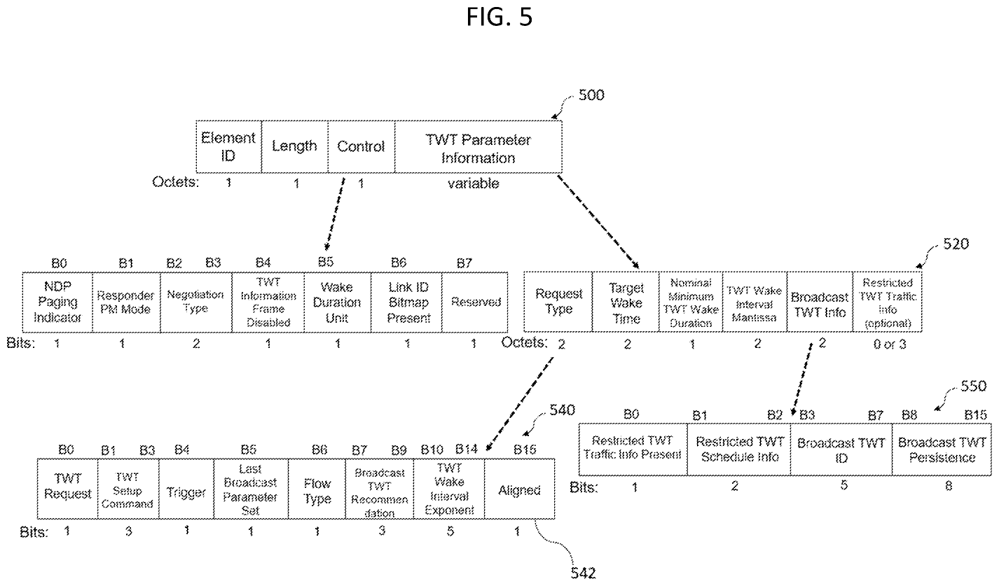

FIG. 5 shows an example of a TWT element 500 in accordance with an embodiment. The TWT element 500 may be applicable to IEEE 802.11be standard and any future amendments to the IEEE standard. The TW element 500 may be included in a broadcast frame, such as a beacon frame, an association response frame, a reassociation response frame, or a probe response frame, transmitted by APs affiliated with the AP MLD.

In FIG. 5, the TWT element 500 may include a Broadcast TWT Parameter Set field 520 which includes a Request Type field 540. The Request Type field 540 may include an Aligned subfield 542. The Aligned subfield 542 may indicate if the corresponding TWT schedule is available on more than one of the links of the AP MLD. For example, if the subfield is set to 1, it may indicate that the schedule is available on multiple links and the target wake times of the schedule on the multiple links are aligned. Otherwise, the schedule is not available on more than one of the links of the AP MLD.

Details about each field and subfields of the TWT element 500 are further explained below. In FIG. 5, the TWT element 500 may include an Element identifier (ID) field, a length field, a Control field, and a TWT Parameter Information field. The Element ID field may include information to identify the TWT element 500. The Length field may indicate a length of the TWT element 400.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and a Reserved subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field 520. The Link ID Bitmap Present subfield may indicate the presence of the Link ID Bitmap field in the Individual TWT Parameter Set field.

The TWT Parameter Information field of the TWT element 500 may include either a single Individual TWT Parameter Set field or one or more Broadcast TWT Parameter Set fields 520. In some implementations, if the Broadcast subfield of the Negotiation Type subfield in the Control field is 0, the TWT Parameter Information field includes the single Individual TWT Parameter Set field. Otherwise, the TWT Parameter Information field includes one or more Broadcast TWT Parameter Set fields. FIG. 5 describes the broadcast TWT as an example where the TWT Parameter Information field may include a Broadcast TWT Parameter Set fields 520.

The Broadcast TWT Parameter Set field 520 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field will be explained in further detail below. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to compete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value.

The Broadcast TWT Info field 550 may include a Restricted TWT Traffic Info Present subfield, a Restricted TWT Schedule Info subfield, a Broadcast TWT ID subfield and a Broadcast TWT Persistence subfield. The Restricted TWT Traffic Info Present subfield may indicate if the Restricted TWT Traffic Info field is present. The Restricted TWT Schedule Info subfield may include information on restricted TWT schedules. The Broadcast TWT ID subfield may indicate a specific Broadcast TWT which the transmitting AP or STA is requesting to participate in, or the transmitting AP or STA is providing TWT parameter for. In some implementations, the Broadcast TWT ID subfield may indicate the broadcast TWT ID of the aligned TWT schedule that corresponds to the Aligned TWT Parameter Set field.

The Broadcast TWT Persistence subfield may indicate the number of TBTT during which the Broadcast TWT SPs corresponding to this broadcast TWT Parameter set are present. The Restricted TWT traffic Info field may be present when the Restricted TWT traffic Info Present subfield of the Broadcast TWT Info subfield is set to 1. In some implementations, the Restricted TWT traffic Info field may be present when the traffic is latency-sensitive traffic.

The Request Type field 540 may include a TWT Request subfield, a TWT Setup Command subfield, a Trigger subfield, a Last Broadcast Parameter Set subfield, a Flow Type subfield, a Broadcast TWT Recommendation subfield, a TWT Wake Interval Exponent subfield, and an Alignment subfield. The Request Type field 540 may be usable for Broadcast TWT operation.

The TWT Request subfield may indicate if the transmitting STA is a TWT scheduling AP (or STA) or a TWT scheduled STA (or AP). The TWT Setup Command subfield may indicate the type of TWT command such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent may indicate the value of the exponent of the TWT wake interval value.

In some implementations, the Negotiation Type subfield in the Control field may determine the interpretation of the Target Wake Time, TWT Wake Interval Mantissa, and TWT Wake Interval Exponent subfields of the TWT element as given by Table 1 below.

TABLE 1

| | | TWT Wake | |
|---|---|---|---|
| | Target | Interval Mantissa | |
| Negotiation | Wake | and TWT Wake | |
| Type | Time | Interval Exponent | |
| subfield | subfield | subfields | Description |
| 0 | A future | Interval between | Individual TWT negotiation between TWT requesting STA |
| | Individual | individual TWT SPs | and TWT responding STA or individual TWT announcement |
| | TWT SP | | by TWT responder. See 10.47 and 26.8.2. |
| | start time | | The TWT element contains one individual TWT parameter set. |
| 1 | Next Wake | Interval between | Wake TBTT and wake interval negotiation between TWT |
| | TBTT time | wake TBTTs | scheduled STA and TWT scheduling AP. See 26.8.6. |
| | | | The TWT element contains one individual TWT parameter set. |
| 2 | A future | Interval between | Provide broadcast TWT schedules to TWT scheduled STAs by |
| | Broadcast | broadcast TWT SPs | including the TWT element in broadcast Management frames |
| | TWT SP | | sent by TWT scheduling AP. See 26.8.3.2. |
| | start time | | The TWT element contains one or more broadcast TWT |
| | | | parameter sets. |
| 3 | A future | Interval between | Manage memberships in broadcast TWT schedules by |
| | Broadcast | broadcast TWT SPs | including the TWT element in individually addressed |
| | TWT SP | | Management frames sent by either a TWT scheduled STA or a |
| | start time | | TWT scheduling AP. See 26.8.3. |
| | | | The TWT element contains one or more broadcast TWT |
| | | | parameter sets. |

The Aligned subfield 542 may indicate whether the corresponding TWT schedule is available on more than one of the links of the AP MLD. More specifically, if the subfield is set to 1, it may indicate that the schedule is available on multiple links and the target wake times of the schedule on the multiple links are aligned. Otherwise, the schedule is not available on more than one of the links of the AP MLD. In some implementations, when a schedule aligns within a predetermined interval, for example 1 TU (time unit), with another schedule, those schedules may be designated as aligned schedules. The predetermined interval in relation to another schedule may vary depending on various embodiments. For instance, it may be multiples of 1 TU interval or an interval shorter than 1 TU. The TU may be a time measurement equal to 1024 μs. The Aligned subfield 542 may be reserved if the Negotiation Type subfield of the Control field in the broadcast TWT element 500 is set to 3 in Table 1 above. For example, the Aligned subfield 542 may be reserved when a TWT scheduling AP or a TWT scheduled STA manages memberships in broadcast TWT schedules by including the TWT element in individually addressed management frames. In an embodiment, the Aligned subfield 542 may be valid if the Negotiation Type subfield of the Control field in the broadcast TWT element is set to 2 in Table 1 above. For example, the Aligned subfield 542 may be valid when the TWT scheduling AP provides broadcast TWT schedules to TWT scheduled STAs by including the TWT element in broadcast management frames.

In some embodiments, when an AP affiliated with an AP MLD includes a Broadcast TWT Parameter Set field 520 containing an aligned schedule within a TWT element 500 during the broadcast TWT announcement phase, the AP may also include an Aligned TWT information element in the same management frame including the TWT element or any other broadcast frame. Details of the Alignment TWT information element will follow below.

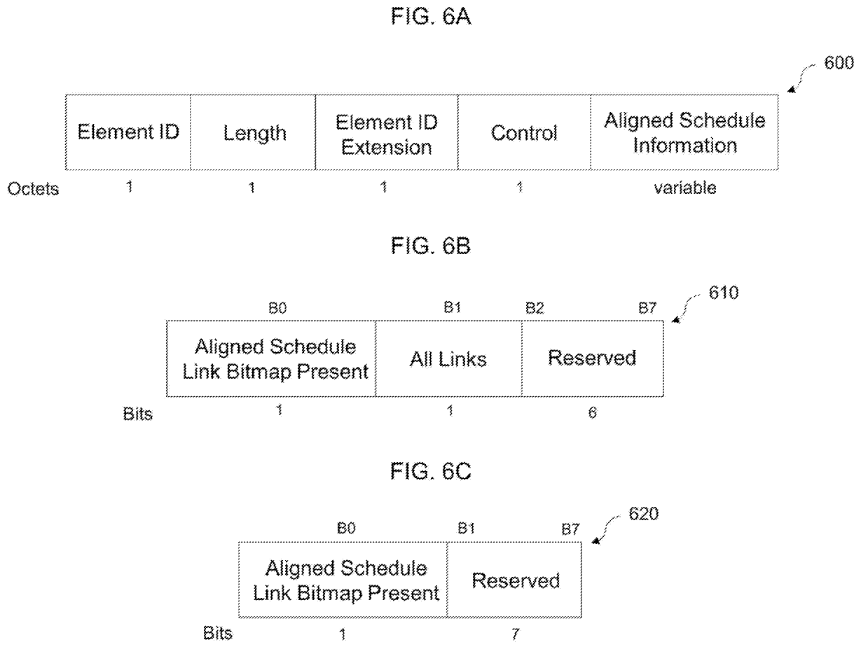

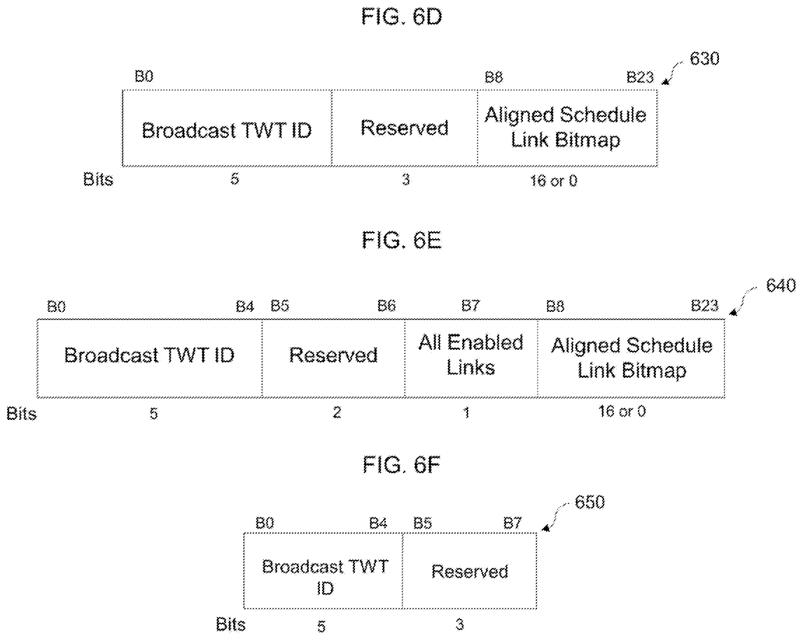

FIG. 6A shows an example of an Aligned TWT information element 600 in accordance with an embodiment. In FIG. 6A, the Aligned TWT information element 600 may include an Element ID field, a Length field, an Element ID Extension field, a Control field, and an Aligned Schedule Information field.

The Element ID field and the Element ID Extension field may include information to identify the Aligned TWT information element 600. The Length field may indicate the length of the Aligned TWT information element 600.

The Control field may include an Aligned Schedule Link Bitmap Present subfield, an All Links subfield, and reserved bits as shown in FIG. 6B. The Aligned Schedule Link Bitmap Present subfield may indicate whether the Aligned Schedule Link Bitmap subfield is present in an Aligned TWT Parameter Set field included within the Aligned Schedule Information field. One or more Aligned TWT Parameter Set fields may be included in the Aligned Schedule information field. More specifically, if the Aligned Schedule Link Bitmap Present subfield is set to 1, it may indicate that all the Aligned TWT Parameter Set fields include the Aligned Schedule Link Bitmap subfield. Otherwise, none of the Aligned TWT Parameter Set fields includes the Aligned Schedule Link Bitmap subfield. The All Links subfield may indicate whether all the schedules that are specified by the Broadcast TWT ID subfield of the Aligned TWT Parameter Set fields in the Aligned TWT information element are available on all the links of the AP MLD. If the All Links subfield is set to 1, it may indicate that all the schedules included in the Aligned TWT information element are available on all links of the AP MLD. Otherwise, all schedules included in the Aligned TWT information element are not available on all the links.

In another embodiment, the Control field may be implemented as shown in FIG. 6C. The Control field 620 may include an Aligned Schedule Link Bitmap Present subfield, and reserved bits. In FIG. 6C, the Aligned Schedule Link Bitmap Present subfield may be similar to or the same as the Aligned Schedule Link Bitmap Present subfield in FIG. 6B. However, the Control field shown in FIG. 6C may not include the All Links subfield of FIG. 6B.

The Aligned Schedule Information field of the Aligned TWT information element 600 may include one or more Aligned TWT Parameter Set fields. Each Aligned TWT Parameter Set field may be associated with a respective one of a plurality of aligned schedules that are advertised by the AP affiliated with the AP MLD.

FIG. 6D shows an example of Aligned TWT Parameter Set field 630 included in the Aligned TWT information element 600. In FIG. 6D, the Aligned TWT Parameter Set field 630 may include a Broadcast TWT ID subfield, a Reserved subfield, and Aligned Schedule Link Bitmap subfield.

The Broadcast TWT ID subfield may indicate the broadcast TWT ID of the aligned TWT schedule that corresponds to the Aligned TWT Parameter Set field. In some implementations, when an aligned schedule is advertised on multiple links by the APs affiliated with an AP MLD, the Broadcast TWT ID subfield in each Aligned TWT Parameter Set field on their respective links may have identical values. However, in some embodiments, the Broadcast TWT ID corresponding to the aligned schedule announced on the two links may be different.

The Aligned Schedule Link Bitmap subfield may indicate the link IDs corresponding to the links of the AP MLD on which the aligned schedule specified by the Broadcast TWT ID subfield is applied. In some implementations, if the bit position i of the Aligned Schedule Link Bitmap subfield is set to 1, it may indicate that the corresponding aligned schedule is available on link i of the AP MLD. Otherwise, the corresponding schedule is not available on link i of the AP MLD. The Aligned Schedule Link Bitmap subfield may be optional. In some implementations, the Aligned Schedule Link Bitmap subfield may not be present when the Aligned Schedule Link Bitmap subfield within the Control field indicates that it is not present.

FIG. 6E shows another example of Aligned TWT Parameter Set field 640 included in the Aligned TWT information element 600. In FIG. 6E, the Aligned TWT Parameter Set field 640 may include a Broadcast TWT ID subfield, a Reserved subfield, an All Enabled Links subfield, and Aligned Schedule Link Bitmap subfield. The Broadcast TWT ID subfield, and the Aligned Schedule Link Bitmap subfield in FIG. 6E are similar to or the same as those in FIG. 6D. The All Enabled Links subfield may indicate availability of the aligned schedule on all links. For example, if the All Enabled Links subfield is set to 1, it may indicate that the corresponding aligned schedule is available on all the links. Otherwise, the corresponding aligned schedule is not available on all the links. In some implementations, if the All Enabled Links subfield is set to 1, the Aligned Schedule Link Bitmap may be absent in the Aligned TWT Parameter Set field.

FIG. 6F shows another example of Aligned TWT Parameter Set field 650 included in the Aligned TWT information element 600. In FIG. 6F, the Aligned TWT Parameter Set field 650 may include a Broadcast TWT ID subfield and Reserved subfield. Compared to FIG. 6D and FIG. 6E, the Aligned TWT Parameter Set field 650 does not include the Aligned Schedule Link Bitmap subfield shown in FIG. 6D and FIG. 6E and All Enabled Links subfield shown in FIG. 6E. The Broadcast TWT ID subfield may be the same as the one in FIG. 6D.

In some embodiments, the TWT scheduling AP affiliated with an AP MLD may indicate whether the schedule is an aligned schedule while announcing a broadcast TWT schedule in its BSS. An aligned schedule is a broadcast TWT schedule that is available across multiple links such that the target wake times of the schedules on the multiple links are aligned. Other TWT parameters of the schedules on those multiple links may remain the same as each other. In some implementations, the TWT scheduling AP affiliated with the AP MLD may explicitly indicate whether the schedule is aligned schedule by setting the Aligned subfield 542 in the Request Type field of the corresponding Broadcast TWT Parameter Set field 520 to 1 in FIG. 5.

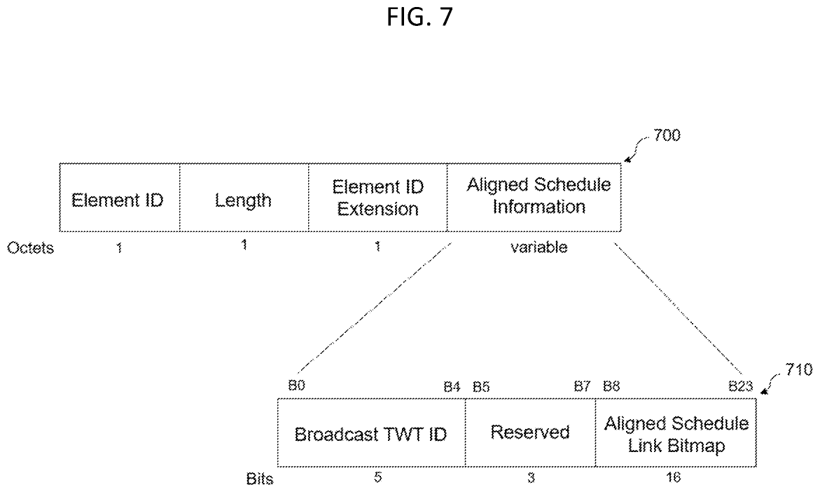

FIG. 7 shows another example of an Aligned TWT information element 700 in accordance with an embodiment. In FIG. 7, the Aligned TWT information element 700 may include an Element ID field, a Length field, an Element ID Extension field, and an Aligned Schedule Information field. Various fields and subfields of the Aligned TWT information element 700 are the same as or similar to corresponding fields and subfields of the Aligned TWT information element 600 shown in FIG. 6A and FIG. 6D. Compared to the Aligned TWT information element 600 shown in FIG. 6A and FIG. 6D, the Aligned TWT information element 700 does not include the Control field and the Aligned Schedule Link Bitmap subfield is always present.

More specifically, the Element ID field and the Element ID Extension field may include information to identify the Aligned TWT information element 700. The Length field may indicate the length of the Aligned TWT information element 700. The Aligned Schedule Information field of the Aligned TWT information element 700 may include one or more Aligned TWT Parameter Set fields. Each Aligned Parameter Set field may be associated with a respective one of a plurality of aligned schedules advertised by the AP affiliated with the AP MLD.

The Aligned TWT Parameter Set field 710 may include a Broadcast TWT ID subfield, a Reserved subfield, and an Aligned Schedule Link Bitmap subfield. The Aligned Scheduled Link Bitmap subfield 710 may be similar to or the same as the Aligned Scheduled Link Bitmap subfield 630 shown in FIG. 6D. In this example, the Aligned Scheduled Link Bitmap subfield 710 has a length of 16 bits and may be always present in the Aligned TWT Parameter Set field. However, the Aligned Scheduled Link Bitmap subfields 630 and 640 shown in FIGS. 6D and 6E are optional and may be absent in some circumstances.

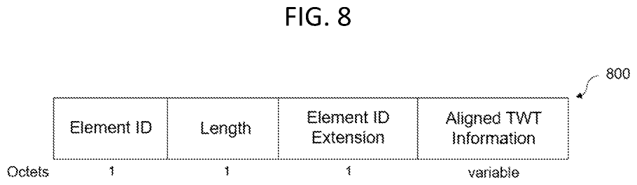

FIG. 8 shows another example of an Aligned TWT information element 800 in accordance with an embodiment. In FIG. 8, the Aligned TWT information element 800 may include an Element ID field, a Length field, an Element ID Extension field, and an Aligned TWT Information field. The Element ID field, the Length field, and the Element ID Extension field are the same as or similar to corresponding fields of the Aligned TWT information element 600 in FIG. 6A. The Aligned TWT Information field may include information related to an aligned TWT. The Aligned TWT Information field may be associated with either an individual TWT or a broadcast TWT.

In some embodiments, the Element ID field and the Element ID Extension field of the Aligned TWT information element 600, 700 and 800 may be implemented as shown in Table 2 below.

TABLE 2
Element IDs

| | | Element | | |
|---|---|---|---|---|
| | Element | ID | Exten- | Fragment- |
| Element | ID | Extension | sible | able |
| Aligned TWT Information | 255 | <ANA> | Yes | Yes |
| (see 9.4.2.xxx Aligned | | | | |
| TWT Information element) | | | | |

In some embodiments, the Aligned TWT information element 600 and 700 may be included in a beacon frame body, an association response frame body, a reassociation response frame body, or a probe response frame body as shown in Tables 3-6 below.

TABLE 3
Beacon frame body

| Order | Information | Notes |
|---|---|---|
| <Last | Aligned TWT | The Aligned TWT Information element is present if |
| assigned + | Information | dot11MultiLinkActivated is true and the TWT scheduling AP has |
| 1> | | included a TWT element that contains at least one Broadcast |
| | | TWT Parameter Set field with the Aligned subfield set to 1: |
| | | otherwise it is not present. |

TABLE 4
Association Response frame body

| Order | Information | Notes |
|---|---|---|
| <Last | Aligned TWT | The Aligned TWT Information element is present if |
| assigned + | Information | dot11MultiLinkActivated is true and the TWT scheduling AP has |
| 1> | | included a TWT element that contains at least one Broadcast |
| | | TWT Parameter Set field with the Aligned subfield set to 1; |
| | | otherwise it is not present. |

TABLE 5
Reassociation Response frame body

| Order | Information | Notes |
|---|---|---|
| <Last | Aligned TWT | The Aligned TWT Information element is present if |
| assigned + | Information | dot11MultiLinkActivated is true and the TWT scheduling AP has |
| 1> | | included a TWT element that contains at least one Broadcast |
| | | TWT Parameter Set field with the Aligned subfield set to 1; |
| | | otherwise it is not present. |

TABLE 6
Probe Response frame body

| Order | Information | Notes |
|---|---|---|
| <Last | Aligned TWT | The Aligned TWT Information element is present if |
| assigned + | Information | dot11MultiLinkActivated is true and the TWT scheduling AP has |
| 1> | | included a TWT element that contains at least one Broadcast |
| | | TWT Parameter Set field with the Aligned subfield set to 1; |
| | | otherwise it is not present. |

In some embodiments, while announcing a broadcast TWT schedule in the AP's BSS, the TWT scheduling AP affiliated with the AP MLD may optionally indicate specific links of the AP MLD on which the aligned schedule is available. This may be achieved by specifying the relevant links in the Aligned Schedule Link Bitmap subfield of the Aligned information element.

In some embodiments, TWT scheduled STAs affiliated with a non-AP MLD that are interested in joining an existing aligned schedule on multiple links may send their requests to join the schedule on those links separately. In some implementations, a TWT scheduled STA affiliated with the non-AP MLD may receive a broadcast TWT element that has a Broadcast TWT Parameter Set filed with the Aligned subfield in the Request Type subfield set to 1. The TWT scheduled STA may expect to receive an Aligned TWT Information element in a broadcast frame transmitted by the TWT scheduling AP affiliated with the AP MLD. The TWT scheduled STA may be informed about the link on which the aligned schedule is available, as indicated by the Aligned Schedule Link Bitmap subfield in the Aligned TWT information element. For example, if bit i of the Aligned Schedule Link Bitmap subfield is set to 1, it may indicate that the aligned schedule is available on the i-th link. Otherwise, the aligned schedule is not available on the i-th link. Further, if the All Links subfield of the Control field 610 of the Aligned TWT information element 600 is set to 1, it may indicate that all the schedules corresponding to all the Aligned TWT Parameter Set fields included in the Aligned TWT Information element 600 are available on all the links corresponding to the APs affiliated with the AP MLD. Otherwise, all the schedules corresponding to all the Aligned TWT Parameter Set fields included in the Aligned TWT Information element are not available on all the links corresponding to the APs affiliated with the AP MLD. When a STA affiliated with the non-AP MLD receives an Aligned TWT information element that does not include an Aligned Schedule Link Bitmap subfield, then a STA affiliated with the same non-AP MLD and operating on a link between the AP MLD and the non-AP MLD may check a beacon frame, a probe response frame, or other broadcast frames to determine whether the corresponding aligned schedule is available on that link.

In some embodiments, when an aligned schedule is available on any two links between an AP MLD and a non-AP MLD, any change made to the TWT parameters of the aligned schedule on a first link may be also applicable to the aligned schedule on a second link. For example, when a first AP operating on the first link makes any changes to the value of the Broadcast Persistence subfield in the Broadcast TWT Info field 550 within the Broadcast TWT Parameter Set field 520, shown in FIG. 5, corresponding to the aligned schedule on the first link, the second AP operating on the second link also makes the same changes to the value of the Broadcast Persistence subfield of the Broadcast TWT Parameter Set field corresponding to the aligned schedule on the second link.

In some embodiments, an aligned schedule may be established on any two links between an AP MLD and a non-AP MLD. In this scenario, if the aligned schedule on a first link is terminated or suspended for a first STA affiliated with the non-AP MLD operating on the first link, the aligned schedule on a second link may continue to remain the same or unchanged for a second STA affiliated with the non-AP MLD operating on the second link. Accordingly, the second schedule for the second link may not be terminated or suspended. In some embodiments, when aligned schedule is terminated or suspended for the first STA operating on the first link, the aligned schedule on the second link may be also terminated or suspended for the second STA affiliated with the same non-AP MLD.

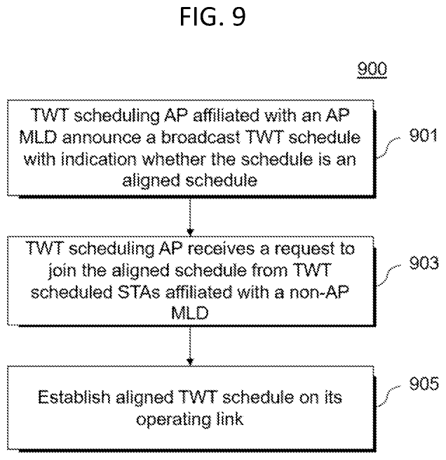

FIG. 9 shows a flow chart illustrating an example process 900 for an AP MLD that supports aligned TWT operation in accordance with an embodiment. To illustrate each operation of the process 900, examples of FIGS. 4 and 5 will be used for explanation. Although one or more operations are described or shown in particular sequential order, in other embodiments the operations may be rearranged in a different order, which may include performance of multiple operations in at least partially overlapping time periods.

The process 900 may begin in operation 901. In operation 901, a TWT scheduling AP affiliated with an AP MLD 410 may explicitly indicate whether the corresponding TWT schedule is an aligned schedule while announcing a broadcast TWT schedule in the AP's BSS using a broadcast frame such as beacon frame or a probe response frame. It may be achieved by setting the Aligned subfield 542 in the corresponding Broadcast TWT Parameter Set field 520 within the TWT element 500 to 1. An aligned schedule is a broadcast TWT schedule that is available across multiple links such that target wake times of those schedules on the multiple links are aligned with each other. Other TWT parameters of the aligned schedules on those multiple links remain the same as each other. The Aligned subfield 542 may indicate whether the corresponding schedule is available on more than one of the links of the AP MLD 410.

In operation 903, the TWT scheduling AP affiliated with the AP MLD 410 may receive a request to join the aligned schedule from a TWT scheduled STA affiliated with the non-AP MLD 420. In some implementations, multiple TWT scheduling APs affiliated with the AP MLD 410 may receive separately multiple requests to join the aligned schedule on their respective links from multiple TWT scheduled STAs affiliated with the non-AP MLD 420 that are interested in joining an existing aligned schedule on multiple links. Then, the process 900 proceeds to the operation 905.

In operation 905, the TWT scheduling AP affiliated with the AP MLD 410 may establish aligned TWT schedule on its operating link. In some implementations, multiple TWT scheduling APs affiliated with the AP MLD 410 may establish aligned TWT schedules on their respective links between the AP MLD 410 and the non-AP MLD 420.

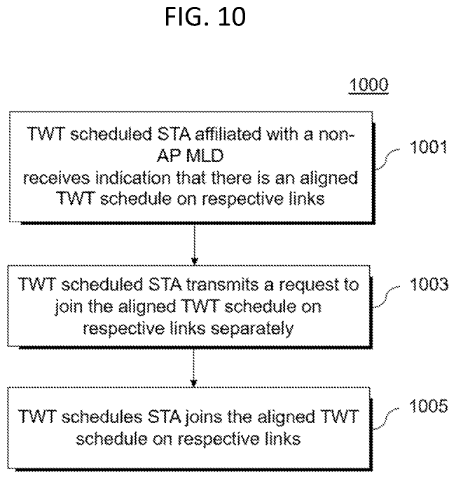

FIG. 10 shows a flow chart illustrating an example process 1000 for a non-AP MLD that supports aligned TWT operation in accordance with an embodiment. To illustrate each operation of the process 1000, examples of FIGS. 4 and 5 will be used for explanation. Although one or more operations are described or shown in particular sequential order, in other embodiments the operations may be rearranged in a different order, which may include performance of multiple operations in at least partially overlapping time periods.

The process 1000 may begin in operation 1001. In operation 1001, a TWT scheduled STA affiliated with a non-AP MLD 420 may receive, from a TWT scheduling AP affiliated with an AP MLD 410, a broadcast frame that includes indication whether the corresponding TWT schedule is aligned schedule. The broadcast frame may be a beacon frame or a probe response frame. Further, the indication may be achieved by setting the Aligned subfield 542 in the corresponding Broadcast TWT Parameter Set field 520 within the TWT element 500 to 1. An aligned schedule is a broadcast TWT schedule that is available across multiple links such that the target wake times of those schedules on the multiple links are aligned with each other. Other TWT parameters of the aligned schedules on those multiple links remain the same as each other. The aligned subfield 542 may indicate whether the corresponding schedule is available on more than one of the links of the AP MLD 410. In some implementations, the TWT scheduled STAs may determine which TWT schedule on their respective links is an aligned schedule using the TWT parameters of the TWT schedule. For example, referring to FIG. 4, after STA 1 of the non-AP MLD 420 operating on Link 1 receives a beacon frame and observes that TWT Schedule 1 is marked as an aligned schedule by the TWT element 500 in the beacon frame, STA 2 and STA 3 of the non-AP MLD 420 operating on Link 2 and Link 3, respectively, may process a communications with AP 2 and AP 3 of the AP MLD 410 on their respective links to determine which TWT schedules on their respective links match with the TWT parameters of the TWT Schedule 1. More specifically, both STA 2 and STA 3 wake up to receive beacon frames on Link 2 and Link 3, respectively to identify the presence of the aligned schedule advertised on Link 1 on their respective links by checking if TWT parameters of their TWT schedules match with the TWT Schedule 1. After identifying the aligned schedule on their respective link, each STA of the non-AP MLD 420 may determine whether they are interested in joining the aligned schedule.

In operation 1003, when the TWT scheduled STA affiliated with non-AP MLD 420 is interested in joining the aligned schedule, the TWT scheduled STA may send a request to join the aligned schedule to the TWT scheduling AP affiliated with the AP MLD 410. In some implementations, when multiple TWT scheduled STAs affiliated with the non-AP MLD 420 are interested in joining the aligned schedule on multiple links, the multiple TWT scheduled STAs may send their requests, to corresponding TWT scheduling APs affiliated with the AP MLD 410, to join the aligned schedule on their respective links separately. Then, the process 1000 proceeds to the operation 1005.

In operation 1005, the TWT scheduled STA affiliated with the non-AP MLD 420 may join the aligned TWT schedule on the corresponding link that is established by the TWT scheduling AP affiliated with the AP MLD 410. In some implementations, multiple TWT scheduled STAs affiliated with the non-AP MLD 420 may join the aligned TWT schedules on their respective links, which are established by the corresponding TWT scheduling APs affiliated with the AP MLD 410.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) multi-link device (MLD) associated with a non-AP MLD in a wireless network, the AP MLD comprising:
at least two APs, each AP being affiliated with the AP MLD; and
a processor coupled to the at least two APs, the processor configured to:
transmit, by a first AP affiliated with the AP MLD to a first STA affiliated with the non-AP MLD on a first link between the first AP and a first STA, a first broadcast frame announcing a first TWT schedule, the first broadcast frame indicating whether the first TWT schedule is an aligned schedule;
receive, by the first AP from the first STA on the first link, a first request to join the first TWT schedule; and
establish, by the first AP on the first link, the first TWT schedule that is aligned with a second TWT schedule established on a second link between a second AP affiliated with the AP MLD and a second STA affiliated with the non-AP MLD.

2. The AP MLD of claim 1, wherein the first broadcast frame comprises a TWT element that includes an aligned subfield indicating whether the aligned schedule is available on more than one of links of the AP MLD.

3. The AP MLD of claim 2, wherein when the aligned subfield is set to a first value, the aligned subfield indicates that there is a schedule on other link that is aligned within a predetermined interval with the first TWT schedule on the first link.

4. The AP MLD of claim 2, wherein when the aligned subfield is set to a second value, the aligned subfield indicates that there is no schedule on other link that is aligned within a predetermined interval with the first TWT schedule on the first link.

5. The AP MLD of claim 2, wherein the aligned subfield is reserved when a negotiation type subfield of a control field of the TWT element indicates that the first AP manages a membership in a TWT schedule by including the TWT element in an individually addressed management frame.

6. The AP MLD of claim 1, wherein the aligned schedule is a broadcast TWT schedule that is available across multiple links and target wake times of broadcast TWT schedules on the multiple links are aligned.

7. The AP MLD of claim 1, wherein TWT parameters of aligned TWT schedules on the multiple links are same as each other.

8. The AP MLD of claim 1, wherein the processor is further configured to:
transmit, by the second AP to the second STA on the second link, a second broadcast frame announcing the second TWT schedule;
receive, by the second AP from the second STA on the second link, a second request to join the second TWT schedule that is aligned with the first TWT schedule established on the first link; and
establish, by the second AP on the second link, the second TWT schedule.

9. The AP MLD of claim 8, wherein the processor is further configured to:
transmit, by a third AP affiliated with the AP MLD from a third STA affiliated with the non-AP MLD on a third link between the third AP and the third STA, a third broadcast frame announcing a third TWT schedule;
receive, by the third AP from the third STA on the third link, a third request to join the third TWT schedule that is aligned with the first TWT schedule established on the first link; and
establish, by the third AP on the third link, the third TWT schedule.

10. A non-access point (AP) multi-link device (MLD) associated with an AP MLD in a wireless network, the non-AP MLD comprising:
at least two stations (STAs), each STA being affiliated with the non-AP MLD; and
a processor coupled to the at least two STAs, the processor configured to:
receive, by a first STA affiliated with the non-AP MLD from a first AP affiliated with the AP MLD on a first link between the first STA and the first AP, a first broadcast frame announcing a first TWT schedule, the first broadcast frame indicating whether the first TWT schedule is an aligned schedule;
transmit, by the first STA to the first AP on the first link, a first request to join the first TWT schedule; and
join the first TWT schedule that is established on the first link, the first TWT schedule being aligned with a second TWT schedule established on a second link between a second STA affiliated with the non-AP MLD and a second AP affiliated with the AP MLD.

11. The non-AP MLD of claim 10, wherein the first broadcast frame comprises a TWT element that includes an aligned subfield indicating whether the aligned schedule is available on more than one of links of the AP MLD.

12. The non-AP MLD of claim 11, wherein when the aligned subfield is set to a first value, the aligned subfield indicates that there is a schedule on other link that is aligned within a predetermined interval with the first TWT schedule on the first link.

13. The non-AP MLD of claim 11, wherein when the aligned subfield is set to a second value, the aligned subfield indicates that there is no schedule on other link that is aligned within a predetermined interval with the first TWT schedule on the first link.

14. The non-AP MLD of claim 11, wherein the aligned subfield is reserved when a negotiation type subfield of a control field of the TWT element indicates that the first AP manages a membership in a TWT schedule by including the TWT element in an individually addressed management frame.

15. The non-AP MLD of claim 10, wherein the aligned schedule is a broadcast TWT schedule that is available across multiple links and target wake times of broadcast TWT schedules on the multiple links are aligned.

16. The non-AP MLD of claim 10, wherein TWT parameters of aligned TWT schedules on the multiple links are same as each other.

17. The non-AP MLD of claim 10, wherein the processor is further configured to:
receive, by the second STA from the second AP on the second link, a second broadcast frame announcing the second TWT schedule;
determine, by the second STA, that the second TWT schedule is the aligned schedule that is aligned with the first TWT schedule based on TWT parameters of the second TWT schedule;
transmit, by the second STA to the second AP on the second link, a second request to join the second TWT schedule; and
join the second TWT schedule that is established on the second link, the second TWT schedule being aligned with the first TWT schedule established on the first link.

18. The non-AP MLD of claim 17, wherein the processor is further configured to:
receive, by a third STA affiliated with the non-AP MLD from a third AP affiliated with the AP MLD on a third link between the third STA and the third AP, a third broadcast frame announcing a third TWT schedule;
determine, by the third STA, that the third TWT schedule is the aligned schedule that is aligned with the first TWT schedule based on TWT parameters of the third TWT schedule;
transmit, by the third STA to the third AP on the second link, a third request to join the third TWT schedule; and
join the third TWT schedule that is established on the third link, the third TWT schedule being aligned with the first TWT schedule established on the first link.

19. A computer-implemented method for facilitating wireless communication, the method comprising:
receiving, by a first station (STA) affiliated with a non-access point (AP) multi-link device (MLD) from a first AP affiliated with an AP MLD associated with the non-AP MLD on a link between the first AP and the first AP, a broadcast frame announcing a broadcast TWT schedule, the broadcast frame indicating whether the broadcast TWT schedule is an aligned schedule;
transmitting, by the first STA to the first AP on the link, a request to join the broadcast TWT schedule when the first STA is interested in joining the broadcast TWT schedule; and
joining the broadcast TWT schedule that is established on the link, the broadcast TWT schedule being aligned with another broadcast TWT schedule established on other link between the non-AP MLD and the AP MLD.

20. The computer-implemented method of claim 19, wherein the broadcast frame comprises a TWT element that includes an aligned subfield indicating whether the aligned schedule is available on more than one of links of the AP MLD.
